(19) United States
(12) Patent Application Publication
(10) Pub. No.: US 2005/0144528 A1
(43) Pub. Date: Jun. 30, 2005

(54) Computing device configuration manager

(76) Inventors: Tim Bucher, Los Altos, CA (US); Tim Sullivan, Portola Valley, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/928,409

(22) Filed: Aug. 26, 2004

Related U.S. Application Data
(60) Provisional application No. 60/498,887, filed on Aug. 29, 2003.

(51) Int. Cl. G06F 11/00

(52) U.S. Cl. 714/38

(57) ABSTRACT

A system, method and software are provided that install a custom configuration profile on one or more target devices, which may be hardwired or wireless devices, and which include personal data assistants, mobile telephones, laptop computers and desktop computers. The custom configuration profile includes a user-specified combination of applications, data, protocols, and policies, suited to a particular target device, and selected in accordance with the desires and requirements of a particular user or group of users. The custom configuration profile can be installed on new devices or on devices that have suffered a catastrophic failure and require reconfiguration. Further, the custom configuration profile is configured to be installed automatically on a target device with little or no involvement on the part of the user, and the installation can be implemented by wireless or hardwire connections between the target device and the backup device where the custom configuration profile is initially stored.

### CROSS REFERENCE TO RELATED APPLICATIONS

This application claims the benefit of U.S. Provisional Application Ser. No. 60/498,887, filed Aug. 29, 2003, which is incorporated herein by reference.

### BACKGROUND OF THE INVENTION

1. Field of the Invention

The present invention relates generally to the configuration of data, applications, and related materials and software, on a computer. More particularly, embodiments of the present invention relate to systems, methods, and software for implementing a customized configuration profile on a selected computing device.

2. Related Technology

Increases in computing speed, efficiency, and power, coupled with a steady decline in retail prices for computing devices, has contributed to a proliferation of computing devices. Such computing devices are employed in a wide variety of environments. For example, desktop type computers are used extensively in business as well as home environments, while portable configurations such as laptops can be used in virtually any location, in addition to being useful in business and home applications.

Further, while computing devices are often traditionally thought of in terms of either a desktop or laptop configuration, there are a variety of other devices that incorporate computing functionality either as their primary purpose, or as an adjunct thereto. For example, computing devices such as personal digital assistants (“PDA”) have been developed that incorporate a significant amount of computing speed and power within a relatively small physical envelope that can easily fit in a briefcase or purse. As another example, mobile phones have been developed that, in addition to their primary communications functionality, further incorporate at least some computing functionality as well.

A variety of software applications have been developed that advantageously employ the computing power and speed provided by such computing devices. In this regard, the number and types of applications that have been developed are virtually endless, with newer, more powerful and more sophisticated applications and revisions being released every day.

Such applications may include or incorporate generalized functionalities such as word processing, internet browsing, spreadsheet functionality and email programs. In other cases, applications are more narrowly tailored to suit specific fields of endeavor or areas of interest. By way of example, specialized applications have been developed for use in such diverse areas as the medical field, engineering design and analyses, and business applications for use in areas such as accounting and finance.

Despite their substantive differences, many of such applications share at least some commonality. As an example, many of such applications are typically supplied to the end user in an optical medium such as a compact disk (“CD”) or magnetic medium such as floppy disk. Such media generally include, in addition to the application, an installation utility which guides the end user through an installation and setup procedure. Further, many specialized applications, as well as general-purpose types of applications, permit a user, either during the initial installation or subsequently, to specify certain aspects relating to the customization of both the application and the user interface presented by the application on the users computing device. In some instances, such customization features are optional and, unless specified otherwise by a user, conform to a predetermined default value. In yet other cases, however, certain aspects relating to the application and its installation must be specified by the user at the time of installation in order to insure proper operation of the application.

One related example concerns the situation where a user is loading an Internet browser program that is to be used in conjunction with a computer that accesses the Internet by way of a dialup connection. In such a case, the user must typically specify such aspects as the dialup access number, and the type of modem through which communication with the dialup network is to be implemented. As another example, certain engineering applications may require a user to specify certain simplifying assumptions or protocols to be used that will guide calculations and analyses performed by the engineering software.

As suggested by the foregoing examples, a user may be required to spend a significant amount of time specifying various parameters and operational aspects in order to tailor the installation of a particular application to suit the requirements and desires of the user. This is particularly true where the user is installing multiple applications. Moreover, the situation is often further complicated by the fact that as applications are upgraded and new versions of the application are made available on the market, the user must typically uninstall the old version and install the new version of the application. In the course of such processes, the user is often required to specify, again, various aspects concerning the installation, operation and interface of the new version of the application.

Some of the problems associated with installations of multiple applications may, in certain cases, be somewhat alleviated through the use of bundled software packages. In general, “bundled software” refers to a package of applications produced by a single developer and installed as a group on the computing device of a user. However, the typical users employ a variety of unbundled applications as well, so the use of one or two bundled packages of software does little to decrease the involvement and time commitment on the part of the user with respect to installing applications software and configuring the application installation to suit the users needs and desires.

Moreover, it may be the case in some instances that the user does not desire to install and use all of the applications in a particular bundle of software, thereby requiring the user to attempt to install only part of the bundle or, alternatively, to install the entire bundle of software and then remove those applications that the user does not desire to use. In either case, a significant amount of involvement and work is required on the part of the user to tailor the installation.

Yet other concerns with such user-customized installations are related to the inability to readily and quickly recreate such installations should the need arise. One example of such a situation is the occurrence of a catastrophic crash or other problem with a computing device that includes data and applications that have been installed in a way that is customized to suit the requirements and desires of the user. In cases such as this, the user is typically compelled to rebuild the customized configuration that was present on the computing device before the crash or other event occurred. The same is likewise true where, for example, another user modifies the customized installation developed by the first user.

As noted earlier, this process is typically quite time-consuming and often requires significant involvement on the part of the user. Moreover, because this rebuilding process requires the use of installation disks containing various applications, the user must gather all of the disks prior to proceeding with the installation. This situation is problematic however, because it is often the case that such installation disks have become lost or misplaced, or otherwise inaccessible to the user, thereby preventing reconstruction of the customized installation previously defined by the user. Further, even where all of the installation disks are available, simply reinstalling the desired applications from the installation disks will not produce the user-customized installation that originally existed.

In particular, and as noted earlier, the user must still specify the various parameters and operational aspects of each such application in order to tailor the installation to suit the requirements and desires of that user.

Finally, it may be also be the case that, notwithstanding a catastrophic event such as a hard disk crash, some or all of the applications on the computing device, although rendered nonfunctional, nevertheless remain on the hard disk, thereby necessitating their removal prior to reinstallation or reconfiguration of the other applications and software in accordance with the desires and requirements of the user.

The rapid pace of the development of computing devices and related hardware further contributes to problems such as those disclosed herein because it is often the case that when a user desires to purchase a new computer, the new computer is supplied to the user with only minimal functionality, such as an operating system and a few basic applications. Thus, the user of a new computer must obtain and install all the necessary application disks and other materials in order to develop a customized installation configuration that conforms with the needs and desires of the user. As noted earlier, this process is not only time-consuming, but typically involves significant effort on the part of the user.

Finally, problems such as those noted herein, whether they occur in the context of rebuilding an existing configuration after a catastrophic event, or whether they occur with respect to a first-time installation on a new computer, are further complicated where the user desires to back up custom data and documents, as well as applications.

In view of the foregoing, and other problems in the art not specifically enumerated herein, what is needed are systems, methods and software that permit a user to readily recreate, and install on a target device, some or all of a custom configuration profile developed by the user. Further, such installation should be capable of being implemented with little or no involvement on the part of the user.

### BRIEF SUMMARY OF AN EXEMPLARY EMBODIMENT OF THE INVENTION

In general, embodiments of the invention are directed to systems, methods, and software for implementing a customized configuration profile on a selected computing device. In one exemplary embodiment of the invention, a parent device, such as a computer, is configured to communicate with a backup device that, in turn, is arranged for communication with one or more target devices. In this exemplary arrangement, the backup device comprises a memory suitable for storing a backup copy of a custom configuration profile that resides on the parent device. The target devices can include, for example, a desktop or personal computer, a laptop computer, a mobile phone, a PDA, or another computing device that executes applications.

In operation, a custom configuration profile is first created on the parent device. The custom configuration profile thus created includes a combination of applications specified by a user, as well as content such as documents and spreadsheets, and various policies associated with, or relating to, the custom configuration profile. The applications may be installed in various ways, such as by media disks provided by the manufacturer, and/or by downloading from Internet websites. The custom configuration profile further includes information concerning various user-customized aspects of the application installations, such as the appearance of the graphical user interface presented by the application. In addition to customized applications, user content, and policies, the custom configuration profile also includes materials not specified by the user, such as communication and data transfer protocols.

As suggested by the foregoing, the custom configuration profile may be created and installed incrementally. Thus, as each new element of the custom configuration profile, whether such element comprises an application, protocol and configuration information, content, and/or policies, is loaded or installed on the parent device, that element, is copied to the backup device and stored there.

In the event that it is desired to install or recreate the custom configuration profile on the target device, as may be the case where the user has purchased a new computer that replaces the original parent device or the parent device has suffered a catastrophic failure, or where undesired modifications have been made to the parent device configuration, such as by another user, or as a result of viruses or other conditions, the user accesses the desired custom configuration profile. In this exemplary embodiment, the licensing requirements of applications included in the custom configuration profile are checked against the materials present on the parent device to ensure that the planned recreation of the custom configuration profile will not violate applicable licensing terms. If necessary, the parent device is scrubbed to remove any materials that may implicate such a violation.

After these processes have been completed, the user then initiates the installation of the custom configuration profile on the parent device. In this exemplary embodiment, no further user involvement is required and the installation proceeds substantially automatically. Upon satisfactory completion of the installation of the custom configuration profile, a corresponding message is displayed on the parent device.

In this way, the user is able to quickly and easily recreate a customized application/data configuration on a target device. Moreover, the installation is effected with minimal user involvement. The invention permits application settings to be preserved in a way that digital content is perpetuated across computing device lifetimes. These and other aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a block diagram that illustrates selected elements of an exemplary operating environment for embodiments of the invention;

FIG. 2 is a flow diagram that illustrates various states in an exemplary embodiment of a process for developing a custom configuration profile

FIG. 3 is a schematic representation of various aspects of an exemplary custom configuration profile;

FIG. 4 is a flow diagram that illustrates various states in an exemplary embodiment of a process for installing a custom configuration profile on a target device; and

FIG. 5 is a block diagram that illustrates various details of an exemplary operating environment for embodiments of the invention.

### DETAILED DESCRIPTION OF EMBODIMENTS OF THE INVENTION

Reference will now be made to the drawings to describe various exemplary embodiments of the invention. It is to be understood that the drawings are diagrammatic and schematic representations of such exemplary embodiments, and are not limiting of the scope of the present invention in any way, nor are they necessarily drawn to scale.

The present invention relates generally to the configuration of data, applications, and related materials and software, on a computer. More particularly, embodiments of the present invention relate to systems, methods, and software for implementing a customized configuration profile on a selected computing device. The customized configuration profile can be updated and modified over the lifetime of a computing device so that it can be used to either recreate the customized application or data configuration of the computer in the event of the installation of a new, replacement computer or the catastrophic failure of the original computer. As described below, the customized configuration profile can include copies of application code that can be used to conveniently install the applications during the process of recreating the computer configuration. This enables new computers to be easily initially configured with minimal user or administrative effort and also permits computer users to avoid the need of maintaining a software library of compact disks or floppy disks storing multiple versions of various applications. In this way, digital content is preserved and perpetuated across computing device lifetimes.

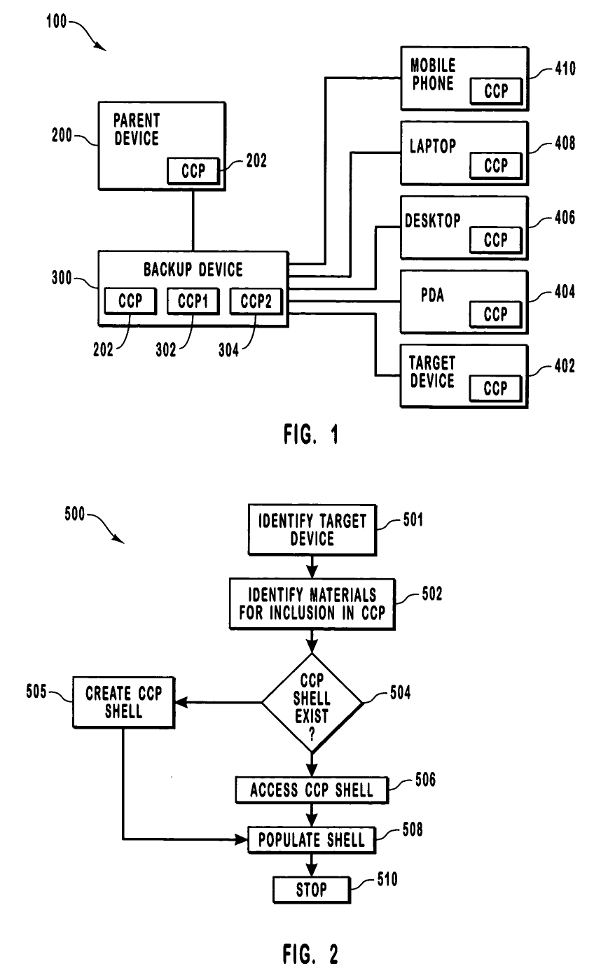

Directing attention now to FIG. 1, various aspects of an exemplary operating environment, denoted at 100, from embodiments of the invention will be briefly considered. Note in this regard that a relatively more detailed discussion of an exemplary operating environment is presented below in connection with the consideration of FIG. 5.

As indicated in FIG. 1, the operating environment 100 exemplarily comprises a parent device 200 that is arranged for communication with a backup device 300. In at least some embodiments of the invention, parent device 200 and backup device 300 comprise a portion of a larger computer network or similar computing environment. As discussed below, parent device 200 and backup device 300 may, in some exemplary configurations, be subsumed within a single device. Communication between the parent device 200 and the backup device 300 may be implemented by various types of wireless systems and devices or, alternatively, maybe implemented by way of systems and devices configured for hardwire communications. In yet other implementations, there is no established communication connection between the parent device 200 and the backup device 300. Rather, in such cases, data and applications are passed between parent device 200 and backup device 300 through the use of portable optical or magnetic media such as optical disks and floppy disks.

With respect to its configuration, parent device 200 may comprise any of a variety of devices configured to store data and/or that includes applications, plug-ins, various protocols, and other systems and software. Exemplary implementations of parent device 200 include, but are not limited to, desktop computers, laptops, mobile telephones, and PDAs. More generally however, parent device 200 maybe implemented in any other form or configuration consistent with the disclosure herein and, accordingly, the scope of the invention should not be construed to be limited to the foregoing exemplary implementations.

The parent device 200 is configured in accordance with a custom configuration profile 202 (“CCP”), also copied to backup device 300, that generally comprises a combination of user-specified elements such as, but not limited to, applications and data, as well as non-user specified elements such as protocols. In general, CCP 202 reflects the needs and requirements of a particular user with respect to the configuration and operation of a particular computing device. Further details concerning the creation, structure and content of exemplary CCPs are provided elsewhere herein.

Generally, the backup device 300 is exemplified as any device that includes a memory or similar structures or devices capable of storing material such as, but not limited to, applications, data, protocols, application binaries, application program interfaces (“API”), and operating systems. In some exemplary embodiments of the invention, backup device 300 comprises a computer. However, backup device 300 may, more generally, be implemented in any form consistent with the disclosure herein.

With continuing reference to FIG. 1, backup device 300 is configured to store a plurality of CCPs in addition to CCP 202, such as CCP 302 and CCP 304. In this way, CCPs for a variety of devices can be backed up on backup device 300 for future use. These CCPs can be maintained and modified during the lifetime of the corresponding devices so that the CCPs are current and available for use at any time. Moreover, while the backup device 300 can be implemented in a variety of computing devices, the backup device, according to one embodiment, is implemented in a network appliance that communicates with parent device 200 and the other devices of FIG. 1 in a way that does not require ongoing user assistance. In this way, the CCPs can be maintained and updated essentially automatically and without ongoing user intervention.

The backup device is further arranged for communication with one or more target devices 402 so that, if necessary, the appropriate CCP stored on backup device 300 can be installed on a selected target device. Specific exemplary implementations of target device 402 include, but are not limited to, PDA 404, desktop computer 406, laptop computer 408, and mobile phone 410, each of which includes a corresponding CCP appropriate to that device.

As in the case of the parent device 200 and the backup device 300, one or more of the target devices 402 through 410 may comprise a portion of a larger network that includes computers and various other devices. Alternatively, and as suggested above, one or more of the target devices 402 through 410 maybe located remotely from parent device 200 and/or backup device 300. In this regard, the communications implemented between backup device 300 and target devices 402 through 410 maybe implemented by wireless systems and devices or, alternatively, may be implemented by way of hardwired systems and devices. In yet other implementations, data and applications may be passed between backup device 300 and one or more of the target devices 402 through 410 through the use of portable optical or magnetic media such as optical disks and floppy disks.

As suggested by the foregoing discussion, the designations ‘parent’ device and ‘target’ device are somewhat arbitrary and have been selected primarily to facilitate clarity of discussion. For example, the parent device 200 indicated in FIG. 1 may additionally, or alternatively, comprise a target device in the sense that a CCP may be created and installed on the parent device 200. Likewise, the exemplary target devices 402 through 410 illustrated in FIG. 1 may additionally, or alternatively, comprise parent devices in the sense that such target devices 402 through 410 each include a CCP that may be backed up on the backup device 300 and later installed on a designated target device.

Directing attention now to FIG. 2, details are provided concerning an exemplary embodiment of a procedure 500 suitable for the creation of a CCP. In some embodiments, the CCP may initially comprise a shell or template containing, for example, nothing more than a set of protocols. In yet other embodiments, the CCP shell may not exist at all or, if such a CCP shell does exist, the CCP shell may initially be empty. In yet other instances, an existing CCP may be retrieved and modified for further use. Thus, procedure 500 may commence from any of a variety of initial states. Note that, as used herein, ‘shell’ and CCP may, in some embodiments, comprise an electronic structure containing various materials. In yet other embodiments, ‘shell’ and/or CCP may simply refer to, for example, a list of applications that a user desires to install, or has installed. Accordingly, the scope of the invention should not be construed to be limited to any particular configuration or implementation of ‘shell’ or ‘CCP.’ Consistent with the foregoing, procedure 500 may, in some exemplary embodiments, comprise the installation of various user-specified, and other, content on a computing device.

With more specific attention now to FIG. 2, procedure 500 is initiated at state 501 wherein the user identifies the type of target device and/or the specific target device with which the CCP is to be employed. In this exemplary procedure, the CCP ultimately created thus corresponds to the type of target device identified by the user. By way of example, if the target device comprises a mobile phone, the procedure 500 will result in creation of a CCP appropriate for a mobile phone. Such a CCP may include, among other things, a list of phone numbers, and appropriate dialing software.

After the target device has been identified, the procedure 500 moves to state 502, in which the user identifies the applications, data, and other elements that the user desires to include in the CCP. In at least some embodiments that include applications downloaded from the Internet, the CCP may also include instructions to check, upon installation of the CCP, whether the CCP includes the most recent version of the downloaded application(s), and to access the appropriate website and download the most recent version if such version is not already included in the CCP.

After the user has identified the content to be included in the CCP, the procedure 500 moves to state 504, in which the user makes a determination as to whether or not a CCP shell exists. If no such shell exists, the procedure 500 moves to state 505 and the user creates an appropriate CCP shell. If, on the other hand, an appropriate CCP shell exists, the procedure 500 moves to state 506 and accesses the CCP shell. In this exemplary procedure, the CCP shell includes only communications protocol and data transfer protocol information. Alternatively, however, the CCP shell may be empty, or comprise other materials.

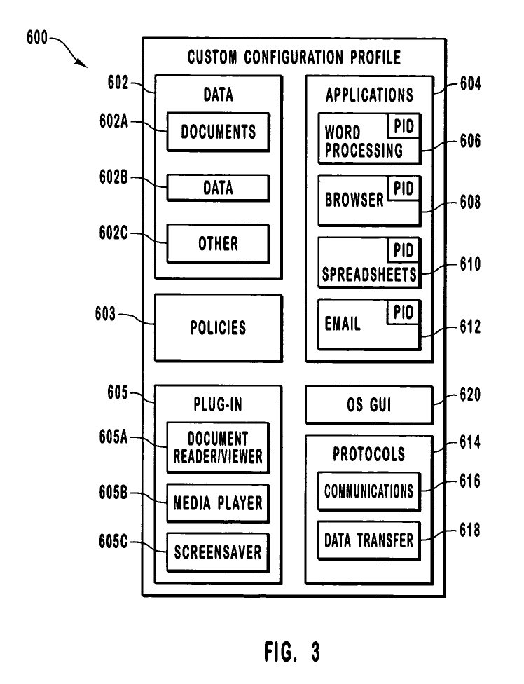

After accessing the CCP shell, the procedure 500 then moves to state 508 and populates the CCP shell by inserting the various applications, data and other elements specified by the user. As noted earlier, the CCP shell may also include certain elements not specified by the user. A more detailed discussion of the content of an exemplary CCP is provided below in connection with the consideration of FIG. 3. After the CCP shell has been populated, the procedure 500 moves to state 510 where procedure 500 terminates.

In addition to the content, applications, protocols, and other materials that may be included in, or otherwise associated with, a particular CCP, various rules or ‘policies’ may also be associated with a CCP, either at the time of its creation, or subsequently. Such policies may be concerned with matters such as, but not limited to, the creation and/or updating of the CCP, the relation of one CCP to another, and the content of the CCP. As with the case of other materials included in, or associated with, the CCP, such policies may be defined by a user, and/or may be selected from a pre-existing list of policies, such as at the time of creation of the CCP.

By way of example, one such policy specifies that any new application loaded by a particular user should automatically be added to the installed CCP of that user as well as to the corresponding CCP that resides on the backup device. Another exemplary policy specifies that a software upgrade downloaded from the Internet to a particular user CCP is also automatically downloaded to any other CCP, in the same network for example, that contains the previous revision of that software.

In addition to the foregoing exemplary user-defined policies, yet other policies may be automatically defined and/or implemented, based upon the materials included in a particular CCP. For example, one policy is configured such that where the CCP comprises only content, such as data and documents, no virus software is included in the CCP, but where the CCP includes one or more applications, virus software is automatically included in the CCP as well. In yet other cases, such policies may be employed to guide creation and/or modification of the CCP. By way of example, in the event that a user specifies certain applications for inclusion in the CCP, that user will be presented with a recommendation that certain virus software be installed. These types of ‘smart’ policies can thus be employed to ensure, among other things, consistency and continuity within a particular CCP or group of CCPs.

With attention now to FIG. 3, details are provided concerning an exemplary embodiment of a CCP, such as may be created by the exemplary process depicted in FIG. 2. In the exemplary illustrated embodiment, the CCP 600 generally comprises a user-specified combination of elements and, in some cases, may further comprise elements that, while not specified by the user, are necessary to the operation of, or otherwise related in some way to, elements selected by the user for inclusion in the CCP 600.

Directing particular attention to the illustrated embodiment of the CCP 600, the exemplary illustrated elements are generally divided into three categories, data 602, policies 603 and applications 604. However, in at least some embodiments of the invention, CCP 600 may comprise only applications and no data. Exemplary data elements include documents 602A and data 602B which may be in raw form, or contained within a database. Various other data elements 602C, such as emails or text messages for example, may also be included. In at least some cases, the format of data elements such as documents 602A and data 602B will correspond to one or more of the applications 604. However, it is not necessary that there be such a correspondence, and the scope of the invention should not be construed to be so limited. In at least some cases, the applications included as part of CCP 600 also include their associated product identifications, or product ‘ID’s.

In this regard, data 602 may take a variety of forms. For example, one or more of documents 602A maybe rendered in formats such as, but not limited to, Word®, WordPerfect®, plain text, or hypertext markup language (“HTML”). Similarly, data elements 602B may comprise data in a variety of formats such as, but not limited to, Excel® or Dbase®. More generally however, data 602 may comprise any type of information rendered in electronic form. Accordingly, data 602 may include, in addition to the exemplary data types disclosed herein, voice, video, and graphical data types, and combinations thereof.

As discussed in detail elsewhere herein, policies 603 may comprise various user-defined policies concerning the content and management of the CCP 600. Further, policies 603 may additionally, or alternatively, comprise certain smart policies that are automatically defined and/or implemented, based upon the materials included in a particular CCP.

With continuing reference to FIG. 3, applications 604 may take a variety of forms. By way of example, some types of applications may comprise plug-ins 605 such as, but not limited to document readers/viewers 605A such as Adobe Acrobat®, various types of media players 605B, and screen saver programs 605C. Moreover, as suggested by the illustrated exemplary embodiment, CCP 600 may include various other applications directed to various activities, wherein such applications may include, but are not limited to, word processing applications 606, internet browsers 608, spread sheet programs 610 and electronic mail program 612. The foregoing represent exemplary combinations only however, and it should be noted that, more generally, any user-specified combination of applications, data, plug-ins, and/or other materials, may likewise be employed.

With respect to applications 704, CCP 600 may further include information concerning various user preferences regarding those applications such as, but not limited to, the appearance of the graphical user interface associated with the application, a font size to be used when opening a document with a particular application such as word processing program 606, a desired homepage to be used for example with internet browser program 608, and/or any other aspect concerning the use or operation of such applications that can be specified by a user consistent with the permissions granted by the application.

As suggested earlier, at least some embodiments of CCP 600 may further include certain elements that, while not specifically identified by user for inclusion in the CCP 600, may nevertheless be useful for the installation and/or use of other elements contained within the CCP 600. By way of example, CCP 600 may include, in some cases, various protocols 614 such as a communications protocol 616 and a data transfer protocol 618.

As another example, some embodiments of CCP 600 also include operating system graphical user interface user preferences 620. In such embodiments, a user may specify, for example, that the operating system, such as Windows® XP, that is associated with a target device should be presented in a particular manner and form desired by the user. In other cases however, the operating system graphical user interface information 620 may be omitted and, in such cases, the operating system of the target device will simply be presented according to default values built within the operating system.

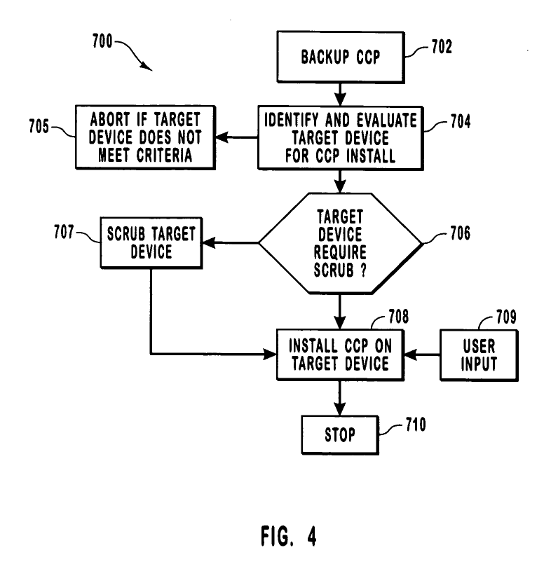

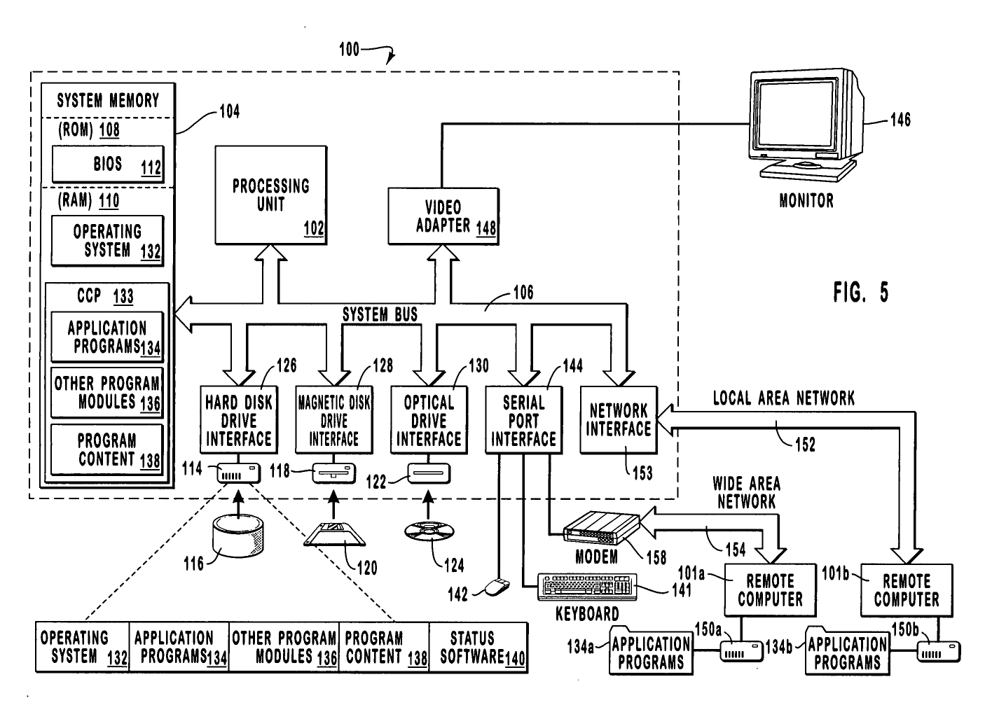

Directing attention now to FIG. 4, details are provided regarding an exemplary CCP installation procedure. As indicated in FIG. 4, a procedure 700 is provided which is directed to various operations concerning the installation of a CCP on a target device. Generally, the procedure 700 is configured to commence after procedure 500, directed to creation of the CCP, is completed. In this regard, it should be noted that various states associated with the exemplary illustrated embodiment of procedure 700 may alternatively be incorporated in procedure 500. The reverse is likewise true. By way of example, the initial state 702 of procedure 700, in which the desired CCP is backed up, may alternatively comprise, for example, the final state of procedure 500. Accordingly, the procedures and associated states disclosed herein are exemplary only, and various additional or alternative procedures and/or states may be employed.

It should be noted that at least some aspects of procedure 700 may be implemented in the form of plug-in software. In particular, such software operates as a plug-in to an operating system on a target device. In this exemplary implementation, the plug-in drives the operating system of the target device, thereby controlling installation of the CCP. Other arrangements are possible as well.

Further, procedure 700 may be implemented in a variety of different situations. As an example, the procedure 700 may be configured to detect, such as in a network environment, a new computing device as the computing device comes ‘on-line’ for the first time. When the new computing device is detected, procedure 700 would commence on the new computing device automatically or in response to input from a user in response to a prompt, thereby obviating the need for network administrators or other personnel to engage in the time-consuming process of configuring the new device.

Additionally, procedure 700 may be implemented on a target device that is a part of the same network as the backup device, or on a target device that is remote from the backup device. By way of example, procedure 700 may be implemented on a PDA by way of a wireless communication link between the PDA and a backup device that is part of a network that does not include the PDA. Finally, some embodiments of the invention are arranged so that installation of the CCP, as exemplified by procedure 700, cannot be performed unless a corresponding uninstall procedure is first performed. In one exemplary embodiment, the user identifications respectively associated with each application in the CCP are tracked by the backup device, or other device, so that an application cannot be installed on a target device unless there is an indication to the backup device that such application has been removed from the device upon which it was initially installed. Thus, if an application is installed on a first target device, and it is later decided to install the corresponding CCP on a second target device, the application must be removed from the first target device prior to being installed on a second target device.

Such functionality would provide a level of assurance that the applications included in the CCP are installed in a manner consistent with applicable licensing, or other, requirements. By way of example, such functionality would prevent an application from being installed on, or residing upon, more than a single target device at any given time.

With continuing reference now to exemplary states of process 700, completion of the CCP backup at state 702 causes procedure 700 to move to state 704 wherein the target device, if not already identified in procedure 500, is identified. Further, various checks are performed on the identified target device, or devices, to determine their capability and suitability for use with the planned CCP installation, or to make other determinations. Such evaluation processes may comprise various aspects.

As an example, the target device is evaluated in some cases to insure that the memory capacity and processing speed of the target device will permit the planned CCP elements to run properly when installed on the target device. Of course, various other parameters of the target device may likewise be identified and evaluated as necessary to facilitate effective installation and use of the CCP. If the evaluation of the target device reveals a problem, or indicates that some aspect of the target device fails to meet certain predetermined criteria, procedure 700 proceeds to state 705 where the CCP installation is aborted. In some instances however, the procedure may continue with only a partial installation of the CCP.

In the event that the target device meets the established criteria, procedure 700 moves on to state 706 where the target device is evaluated to determine whether installation of some or all of the intended CCP would violate the terms of any applicable license agreements, such as license agreements concerning applications included in the CCP. If a determination is made that one or more of the target devices contains materials that, either alone, or in combination with CCP elements, would violate an applicable license agreement upon installation of the CCP, the procedure 700 moves to state 707 wherein the identified target devices are scrubbed in a manner consistent with the applicable license agreement.

Exemplarily, such scrubbing comprises removal of materials from the memory of the target device, wherein such materials may comprise, among other things, data and applications. In yet other cases, scrubbing may comprise processes such as, but not limited to, encrypting or disabling such materials, or otherwise rendering such materials unusable, irretrievable and/or inaccessible.

Upon completion of any required scrubbing, the procedure 700 moves to state 708 after the scrub has been completed. If, on the other hand, it is determined at state 706 that no scrubbing is required, the procedure 700 moves directly to state 708 wherein the CCP is installed on the target device. In at least some embodiments, the CCP is installed in a manner similar to that employed to install the individual components of bundled software. Various other procedures may alternatively be employed however.

In connection with the foregoing, the procedure 700 may be constructed so that installation of the CCP on the target device is based at least in part upon user input, as indicated at 709. As noted elsewhere herein however, procedure 700 may, in other cases, proceed substantially automatically with little or no involvement on the part of the user. Thus, some embodiments of the invention are configured for a ‘hands-free’ CCP installation, while other embodiments of the invention allow for a predetermined level of user input with respect to the installation of the CCP on the target device.

In cases where the user is involved in the installation of the CCP on the target device, the user may provide input that, among other things, further refines the CCP that is to be installed. By way of example, a user may be prompted to accept or decline the installation of some or all of the applications, or other elements, associated with the CCP. As another example, procedure 700 may prompt a user to supply or confirm the product ID that corresponds to each application that is to be installed.

In addition to the foregoing, at least some embodiments of procedure 700 provide for transmitting feedback concerning various aspects of the CCP installation. In one implementation, successful installation of the CCP is indicated by a message displayed on the target device, or otherwise transmitted to a predetermined recipient. Further, where problems are encountered during installation of the CCP, one or more corresponding messages are transmitted to a predetermined recipient. Messages such as those disclosed herein may take various forms including, but not limited to, displayed messages, electronic mail, or phone calls. In any event, at such time as the installation of the desired CCP is installed on the target device(s), procedure 700 then moves to state 710 and terminates.

As evidenced by the foregoing discussion, one aspect of exemplary embodiments of the invention is that a user can readily recreate a desired CCP on either a new computer, or a computer that has suffered a catastrophic failure or has otherwise experienced loss of its existing configuration, with little or no effort, by simply installing the CCP on the target device. This arrangement precludes the need for the user to locate backup disks for all of the applications desired by the users and also precludes the need for the user to be involved in the installation process, as at least some embodiments of the invention are configured for substantially automatic installation.

The original CCP and the recreated CCP are described herein as being “substantially similar”. This term indicates that the recreation of the customized configuration profile on either the original device or on a new, replacement device, restores or establishes the configuration of the device to have at least some of the same applications and to have a set of common characteristics that existed in the original configuration. These configurations can be “substantially similar” without being identical which, in many instances will not be possible due to hardware differences between an original computer and a replacement computer or for other such reasons. In any event, the CCP can be recreated in this manner without substantial user involvement, which means that the user is not required to direct the creation of the configuration or to manually perform the installation of the applications.

As an example, the user may, if desired, cause the CCP to be installed at night while the computer is not being used so that upon accessing the computer the following morning, the user will immediately be able to use the computer as all of the desired applications and data, in the form and configuration desired by the user, have been installed on the target device. Of course, the same is likewise true with respect to other target devices such as PDAs and mobile phones.

Further, as discussed herein, embodiments of the invention are suitable for use with a wide variety of computing devices and are not limited solely to use in connection with devices that have computing as their primary purpose or function. Moreover, embodiments of the invention are well-suited for initially configuring new devices, as well as re-configuring existing devices that have suffered some type of catastrophic failure, or that otherwise require installation of a particular package of elements such as applications and data.

With attention now to FIG. 5, more detailed information is provided concerning various aspects of an exemplary operating environment for embodiments of the invention. As suggested earlier, embodiments of the present invention may be implemented with a special purpose or general purpose computer including various computer hardware, as discussed in greater detail below. Embodiments within the scope of the present invention also include computer-readable media for carrying or having computer-executable instructions or electronic content structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or electronic content structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and content that cause a general purpose computer, special purpose computer, or special purpose processing device to perform a certain function or group of functions.

FIG. 5 and the following discussion are intended to provide a brief, general description of an exemplary computing environment in which the invention may be implemented. Although not required, aspects of the invention may be described in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of the program code means for executing steps of the methods disclosed herein. The particular sequence of such executable instructions or associated content structures represent examples of corresponding acts for implementing the functions described in such steps.

Of course, the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a client network. In a distributed computing environment for example, program modules may be located in both local and remote memory storage devices.

With more particular reference now to FIG. 5, an exemplary system for implementing the invention includes a general purpose computing device in the form of a conventional computer 101, including a processing unit 102, a system memory 104, and a system bus 106 that couples various system components including system memory 104 to processing unit 102. System bus 106 may be any of several types of bus structures including a memory bus or memory controller, a peripheral bus, and a local bus using any of a variety of bus architectures. System memory 104 includes read only memory (ROM) 108 and random access memory (RAM) 110. A basic input/output system (BIOS) 112, containing the basic routines that help transfer information between elements within computer 101, such as during start-up, may be stored in ROM 108.

Computer 101 may also include a magnetic hard disk drive 114 for reading from and writing to a magnetic hard disk 116, a magnetic disk drive 118 for reading from or writing to a removable magnetic disk 120, and an optical disk drive 122 for reading from or writing to removable optical disk 124 such as a CD-ROM or other optical media. Magnetic hard disk drive 114, magnetic disk drive 118, and optical disk drive 122 are connected to system bus 106 by a hard disk drive interface 126, a magnetic disk drive interface 128, and an optical disk drive interface 130, respectively. The drives and their associated computer-readable media provide nonvolatile storage of computer-executable instructions, content structures, program modules and other content for computer 101.

Although the exemplary environment described herein employs a magnetic hard disk 116, a removable magnetic disk 120 and a removable optical disk 124, other types of computer readable media for storing content can be used, including magnetic cassettes, flash memory cards or other types of memory expansion cards, digital video disks, Bernoulli cartridges, RAMs, ROMs, and the like.

Program code means comprising one or more program modules may be stored on hard disk 116, magnetic disk 120, optical disk 124, ROM 108 or RAM 110, including an operating system 132, and a custom configuration profile, or CCP, 133 that includes one or more application programs 134 capable of implementing various aspects of the methods and systems disclosed herein, other program modules 136, and program content 138.

A user may enter commands and information into computer 101 through keyboard 141, pointing device 142, or other input devices (not shown), such as a microphone, joy stick, game pad, satellite dish, scanner, or the like. These and other input devices are often connected to processing unit 102 through a serial port interface 144 coupled to system bus 106. Alternatively, the input devices may be connected by other interfaces, such as a parallel port, a game port or a universal serial bus (USB). A monitor 146 or another display device is also connected to system bus 106 via an interface, such as video adapter 148. In addition to monitor 146, personal computers typically include other peripheral output devices (not shown), such as speakers, printers, scanners, and the like.

Computer 101 may operate in a networked environment using logical connections to one or more remote computers, such as remote computers 101A and 101B. Remote computers 101A and 101B may each be another personal computer, a server, a router, a network PC, a peer device or other common network node, and typically includes many or all of the elements described above relative to computer 101, although only memory storage devices 150A and 150B and their associated application programs 134A and 134B have been illustrated in FIG. 5. The logical connections depicted in FIG. 5 include a local area network (LAN) 152, and Wide Area Network (WAN) 154 and other networks that typically cover a wide geographic area such as a state or country. WAN type networking environments are commonplace in office-wide or enterprise-wide computer networks, intranets and the Internet. It should be noted that embodiments of the present invention may also be employed in the context of a global computer network 300. In general, the aforementioned are exemplary operating environments and are not intended to limit the scope of the invention in any way.

When used in a LAN networking environment for example, computer 101 is connected to LAN 152 through a network interface 156. When used in a WAN 154 networking environment, computer 101 may include a modem 158, a wireless link, or other means for establishing communications over WAN 154. Modem 158, which may be internal or external to computer 101, is connected to system bus 106 via serial port interface 144. In a networked environment, program modules depicted relative to computer 101, or portions thereof, may be stored in a remote memory storage device. Of course, the network connections shown are exemplary and other means of establishing communications over LAN 152 and/or WAN 154 may alternatively be employed.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

1. A method for at least partially recreating an existing custom configuration profile on a target device, the method comprising the acts of:
creating a version of the existing custom configuration profile, the created version of the existing custom configuration profile comprising a user-specified combination of elements that includes at least one application;
storing the version of the existing custom configuration profile; and
causing the version of the existing custom configuration profile to be installed on the target device.

2. The method as recited in claim 1, wherein:
the existing configuration profile has been created based on an existing configuration of a parent device;
the target device is a replacement for the parent device; and
the act of causing the version of the existing custom configuration profile to be installed on the target device is performed such that the target device obtains a configuration that is substantially similar to the existing configuration of the parent device.

3. The method as recited in claim 1, wherein:
the existing configuration profile has been created based on an existing configuration of a parent device;
the target device is the parent device after the parent device has experienced loss of the existing configuration; and
the act of causing the version of the existing custom configuration profile to be installed on the target device is performed such that the target device obtains a configuration that is substantially similar to the existing configuration of the parent device.

4. The method as recited in claim 1, wherein the version of the existing custom configuration profile comprises a plurality of applications.

5. The method as recited in claim 1, wherein the version of the existing custom configuration profile further comprises data.

6. The method as recited in claim 1, wherein the version of the existing custom configuration profile further comprises at least one policy.

7. The method as recited in claim 1, wherein the version of the existing custom configuration profile further comprises at least one non user-specified element.

8. The method as recited in claim 1, further comprising evaluating the target device for conformance with a predetermined criterion.

9. The method as recited in claim 1, wherein installation of the version of the existing custom configuration profile occurs without substantial user involvement.

10. The method as recited in claim 1, wherein causing the version of the existing custom configuration profile to be installed on the target device comprises transmitting the stored version of the existing custom configuration profile to the target device over a wireless connection.

11. The method as recited in claim 1, wherein causing the version of the existing custom configuration profile to be installed on the target device comprises transmitting the stored version of the existing custom configuration profile to the target device over a hardwire connection.

12. The method as recited in claim 1, further comprising evaluating the target device to determine whether installation of the version of the existing custom configuration profile would be consistent with licensing terms associated with the at least one application.

13. The method as recited in claim 1, further comprising removing from the target device any materials inconsistent with licensing terms associated with the at least one application included in the version of the existing custom configuration profile.

14. The method as recited in claim 1, further comprising automatically modifying the existing custom configuration profile and the version of the existing custom configuration profile, in accordance with a policy.

15. A method for capturing a custom configuration profile and at least partially recreating the captured custom configuration profile on a target device that includes an operating system, the method comprising the acts of:
creating a custom configuration profile comprising a user-specified combination of elements that includes a plurality of application;
creating a version of the custom configuration profile; and
causing at least a portion of the created version of the custom configuration profile to be installed on the target device, the installed portion of the created version of the custom configuration profile comprising a plurality of applications.

16. The method as recited in claim 15, wherein the created custom configuration profile further comprises data.

17. The method as recited in claim 15, wherein the created custom configuration profile further comprises a policy.

18. The method as recited in claim 15, wherein creating a custom configuration profile comprises loading the user-specified combination of elements on a parent device.

19. The method as recited in claim 15, further comprising storing the created custom configuration profile on a backup device.

20. The method as recited in claim 15, further comprising evaluating the target device for conformance with a predetermined criterion.

21. The method as recited in claim 15, further comprising ensuring that the plurality of applications in the custom configuration profile are suitable for use with the target device.

22. The method as recited in claim 15, wherein causing at least a portion of the created version of the custom configuration profile to be installed on the target device comprises causing the operating system of the target device to install the at least a portion of the created version of the custom configuration profile.

23. The method as recited in claim 15, wherein creation of the custom configuration profile is guided at least in part by a policy.

24. In a computing environment that includes a plurality of devices, at least some of which are configured for communication with each other, a computer program product for implementing a method for at least partially recreating an existing custom configuration profile on a target device, the computer program product comprising:
a computer readable medium carrying computer executable instructions for performing the method, wherein the method comprises:
creating a version of the existing custom configuration profile, the created version of the existing custom configuration profile comprising a user-specified combination of elements that includes at least one application;
storing the version of the custom configuration profile; and
causing at least a portion of the version of the custom configuration profile to be installed on the target device.

25. The computer program product as recited in claim 24, wherein the version of the existing custom configuration profile comprises a plurality of applications.

26. The computer program product as recited in claim 24, wherein the version of the existing custom configuration profile further comprises data.

27. The computer program product as recited in claim 24, wherein the version of the existing custom configuration profile further comprises a policy.

28. The computer program product as recited in claim 24, wherein the version of the existing custom configuration profile further comprises at least one non user-specified element.

29. The computer program product as recited in claim 24, further comprising evaluating the target device for conformance with a predetermined criterion.

30. The computer program product as recited in claim 24, wherein installation of the version of the existing custom configuration profile occurs without substantial user involvement.

31. The computer program product as recited in claim 24, wherein the created version of the existing custom configuration profile is substantially the same as the existing custom configuration profile.

32. The computer program product as recited in claim 24, further comprising evaluating the target device to determine whether installation of the version of the existing custom configuration profile would be consistent with licensing terms associated with the at least one application.

33. The computer program product as recited in claim 24, further comprising removing from the target device any materials inconsistent with licensing terms associated with the at least one application included in the version of the existing custom configuration profile.

34. The computer program product as recited in claim 24, further comprising automatically modifying the existing custom configuration profile and the version of the existing custom configuration profile, in accordance with a policy.

35. In a computing environment that includes a plurality of devices, at least some of which are configured for communication with each other, a computer program product for implementing a method for capturing a custom configuration profile and at least partially recreating the captured custom configuration profile on a target device that includes an operating system, the computer program product comprising:
a computer readable medium carrying computer executable instructions for performing the method, wherein the method comprises:
creating a custom configuration profile comprising a user-specified combination of elements that includes a plurality of application;
creating a version of the custom configuration profile; and
causing at least a portion of the created version of the custom configuration profile to be installed on the target device, the installed portion of the created version of the custom configuration profile comprising a plurality of applications.

36. The computer program product as recited in claim 35, wherein the created custom configuration profile further comprises data.

37. The computer program product as recited in claim 35, wherein the created custom configuration profile further comprises a policy.

38. The computer program product as recited in claim 35, wherein creating a custom configuration profile comprises loading the user-specified combination of elements on a parent device.

39. The computer program product as recited in claim 35, further comprising storing the created custom configuration profile on a backup device.

40. The computer program product as recited in claim 35, further comprising evaluating, for conformance with a predetermined criterion, at least one of: the target device; and one or more of the other devices in the computing environment.

41. The computer program product as recited in claim 35, further comprising ensuring that the plurality of applications in the custom configuration profile are suitable for use with the target device.

42. The computer program product as recited in claim 35, wherein causing at least a portion of the created version of the custom configuration profile to be installed on the target device comprises causing the operating system of the target device to install the at least a portion of the created version of the custom configuration profile.
